(19) United States
(12) Patent Application Publication
(10) Pub. No.: US 2010/0094736 A1
(43) Pub. Date: Apr. 15, 2010

(54) Arrangement and Method for Providing Data

(75) Inventor: Norbert Loebig, Darmstadt (DE)

Correspondence Address: MICHAEL N. HAYNES, 1341 HUNTERSFIELD CLOSE, KESWICK, VA, 22947, US

(73) Assignee: NOKIASIEMENS NETOWORKS GMBH & CO. KG, MUNICH (DE)

(21) Appl. No.: 12/445,484

(22) PCT Filed: Oct. 15, 2007
(86) PCT No.: PCT/EP07/60979

§ 371 Date: Apr. 14, 2009

(30) Foreign Application Priority Data
Oct. 17, 2006 (DE) 10 2006 048 980.2

(51) Int. Cl. G06Q 20/00; G06Q 30/00; G06Q 50/00; G06F 15/16

(52) U.S. Cl. 705/34; 705/40; 709/207

(57) ABSTRACT

In an arrangement and the corresponding method for providing data MM1, MM2, . . . MMn that is subject to a charge, particularly multimedia data, access information ZI1, ZI2, . . . Zln associated with data MM1, MM2, . . . MMn, which can be selected and is subject to a charge, is deposited in a means E before a payment process.

The invention relates to an arrangement which is specified in the preamble of patent claim 1 and to a method, which is specified in the preamble of claim 6, for providing charge-incurring data, such as multimedia data.

To be able to access charge-incurring data at the receiver end, access information, such as a channel number and a digital rights management key, is provided after a payment operation by the receiver. The payment operation is linked to the checking of a credit or of a credit worthiness for a customer and to storage of data at a central location in line with the payment, for example.

However, such an arrangement and the associated method have the drawback that the access information is not provided until after a successful payment operation. If there is a fault or delay in the payment operation, for example in the event of an overload or failure of central units, the receiver is unable to access charge-incurring data, or is able to access them only after a delay.

It is an object of the present invention to specify an arrangement and a method which avoid this drawback.

The invention achieves the stated object by means of the features cited in patent claim 1 or 6.

The measures according to the invention result in the advantage that access information for charge-incurring data is actually stored by the receiver end before a payment operation, and therefore charge-incurring data can be accessed by the receiver regardless of delays in the payment operation which are dependent on load or due to failure.

The subject matter of the invention affords the further advantage that particularly that access information for which an overload situation during payment for charge-incurring data is expected or has been established is stored at the receiver end.

The subject matter of the invention affords the further advantage that the output of and payment for charge-incurring data are ensured regardless of load and failure.

Further advantageous embodiments are specified in the sub claims.

### BRIEF DESCRIPTION OF THE DRAWINGS

Further special attributes of the invention become clear from the following explanations of a plurality of exemplary embodiments with reference to drawings, in which:

FIG. 1 is a a block diagram of a subscriber unit,

FIG. 2 is a block diagram of an arrangement for providing data, and

FIG. 3 is a block diagram of a data transmission network.

The invention describes an arrangement and the associated method for providing charge-incurring data MM1, MM2, . . . MMn, for example television programs or videos, having a means E, for example a set-top box in which access information ZI1, ZI2, . . . ZIn associated with selectable or determinable, charge-incurring data MM1, MM2, . . . MMn can be stored before a payment operation, and the charge-incurring data MM1, MM2, . . . MMn can be output to an output unit AE, for example a television set.

The means E is used to store only that access information ZI1, ZI2, . . . ZIn, for example, for which the means E or a central unit B has ascertained a current or expected overload situation for the payment operation for charge-incurring data MM1, MM2, . . . MMn or for which the means E or a central unit B is informed of a current or expected overload situation for the payment operation for charge-incurring data MM1, MM2, . . . MMn by means of an interface, e.g. a signaling interface or a user interface.

Prior to or during the output of the charge-incurring data MM1, MM2, . . . MMn, the means E transmits the enabling data, which are required for the payment operation and can be input by the receiver, to the central unit B and terminates the output of the charge-incurring data MM1, MM2, . . . MMn if no positive acknowledgement of the payment operation is received from the central unit B within a stipulatable time period or if a negative acknowledgement of the payment operation is received from the central unit B.

The means E uses the access information ZI1, ZI2, . . . ZIn stored in the means E for the purpose of outputting the charge-incurring data MM1, MM2, . . . MMn unreservedly or with some reservations particularly if the means E ascertains an overload situation, a failure situation or a fault during the payment operation prior to or upon output of the charge-incurring data MM1, MM2, . . . MMn.

In the event of a delay or a fault in the payment operation for charge-incurring data MM1, MM2, . . . MMn which are to be paid for, the means E uses the access information ZI1, ZI2, . . . ZIn stored in the means E.

The means E continues to turn to the central unit B for payment for charge-incurring data MM1, MM2, . . . MMn which are to be paid for until the payment operation has been completed successfully. This may also occur particularly during or after output of the charge-incurring data MM1, MM2, . . . MMn.

By way of example, the access information ZI1, ZI2, . . . ZIn contains address information about sources of the charge-incurring data MM1, MM2, . . . MMn, particularly Internet Protocol addresses of servers or of multicast groups and/or data store addresses which the means E can use to access the selectable, charge-incurring data MM1, MM2, . . . MMn.

By way of example, the access information ZI1, ZI2, . . . ZIn contains information which the means E can use to decrypt the selectable, charge-incurring data MM1, MM2, . . . MMn and/or to customize them to the needs of the interface to the output unit AE.

When charge-incurring data MM1, MM2, . . . MMn are selected by the subscriber, the means E can request the data required for the payment operation from the subscriber and transmit them to the central unit B. In the event of an unsuccessful payment operation being reported to the means E, output of the charge-incurring data MM1, MM2, . . . MMn is terminated or a fresh request is made for the data required for the payment operation, and said data are transmitted to the central unit B again. The fresh request for the data required for the payment operation is preferably made without interrupting output of the charge-incurring data.

A fresh request for the data required for the payment operation is made particularly in the event of incorrect subscriber inputs.

The output is terminated in the event of an insufficient balance or credit or repeatedly incorrect subscriber inputs for the payment operation. In the event of termination or in the event of a repeated request for the data required for the payment operation, the means E outputs explanatory information to the output unit AE for a subscriber.

The means E stores the data required for the payment operation locally, for example, in nonvolatile fashion and transmits them repeatedly to the central unit B until a payment acknowledgement is received from the central unit B.

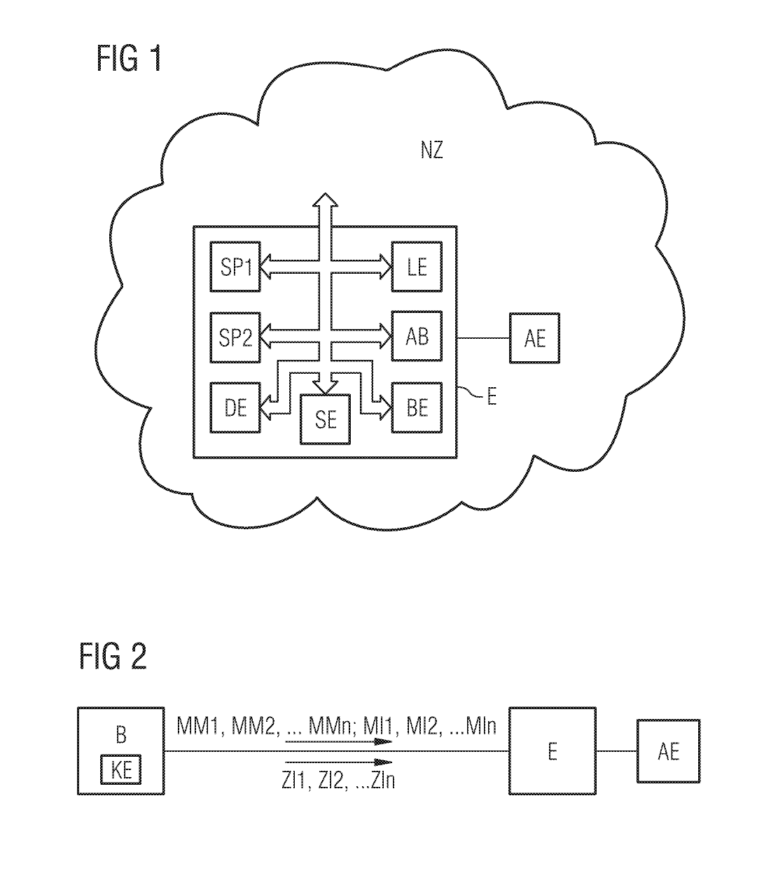

FIG. 1 shows a means E having a first and a second memory unit SP1, SP2, a recognition unit LE, a termination unit AB, an operator control unit BE, a data reading unit DE and a data interface unit SE. The means E is connected to an output unit AE, for example a television receiver, for the purpose of outputting and displaying data.

The first memory unit SP1 is used to store access information ZI1, ZI2, . . . ZIn for evaluating and outputting charge-incurring data MM1, MM2, . . . MMn, for example television programs or video data. The second memory unit SP2 can be used to buffer-store charge-incurring data MM1, MM2, . . . MMn when required. The memory units SP1 and SP2 may alternatively also be combined in a single memory unit. The data input unit DE, for example a DVD drive or a memory chip interface, is provided for the input of charge-incurring data MM1, MM2, . . . MMn stored on data storage media.

The data interface unit SE is connected to a data transmission network NZ, for example an Internet Protocol network. The data interface unit SE can be used by the means E to receive, by way of example, charge-incurring data MM1, MM2, . . . MMn, access information ZI1, ZI2, . . . ZIn or data information MI1, MI2, . . . MIn associated with the charge-incurring data MM1, MM2, . . . MMn, such as program information.

When the recognition unit LE outputs first signaling S1, the means E outputs the charge-incurring data MM1, MM2, . . . MMn using the access information ZI1, ZI2, . . . ZIn stored in the first memory unit SP1. By way of example, the first signaling S1 indicates a current or expected overload situation for a subscriber-end operation for paying for the charge-incurring data MM1, MM2, . . . MMn. More generally, a criterion for generating the first signaling S1 may be, for example, the absence of acknowledgements by the central provision unit B which are required in the course of a payment operation, or the presence of access information ZI1, . . . ZIn stored locally in the means E, or the accessibility of the access information ZI1, . . . ZIn by the means E, or the receipt of an external message in the means E, or untimely receipt of an external message in the means E, or an input on the operator control unit BE.

While the termination unit AB is not outputting second signaling S2, output of the charge-incurring data MM1, MM2, . . . MMn is continued. The termination unit AB outputs second signaling S2 when a subscriber-end payment operation for paying for the charge-incurring data MM1, MM2, . . . MMn has not been successfully completed within a stipulatable time period.

Third signaling S3 is applied to the means E externally. It arrives via the interface unit SE. Third signaling may be generated by the central provision unit B, for example. It may result particularly from an operator control operation on the provision unit B or from an automatic sequence. The third signaling can transport particularly at least one of the pieces of access information ZI1, . . . .ZIn and prompt storage thereof in the unit SP1. The third signaling can equally prompt particularly the request for at least one of the pieces of access information ZI1, . . . ZIn with subsequent storage in the unit SP1. The third signaling can particularly also prompt use of an already locally stored piece of access information ZI1, . . . .ZIn for the output of charge-incurring data MM1, . . . MMn.

The exemplary embodiment in FIG. 2 schematically shows a means E, for example a set-top box, connected to a central unit B, for example a service coordination unit. The connection may be part of an Internet-Protocol-based network, for example. The means E receive both charge-free data and charge-incurring data MM1, MM2, . . . MMn which are provided from a data source TVEC under the control of the central unit B. In the present exemplary embodiment, the data source TVEC is identical to the provision unit B. In addition, data information MI1, MI2, . . . MIn associated with the data MM1, MM2, . . . MMn and describing the data content and the start and end times for a data transmission, for example, and also access information ZI1, ZI2, . . . ZIn are also provided by the central unit B and received by the means E. More generally, the associated data information MI1, . . . MIn and/or the access information ZI1, . . . ZIn can be received in the means E fully or partially from further units, other than the provision unit B, too under the control of the provision unit B. An identification unit KE in the central unit B can mark the freely selectable data information MI1, MI2, . . . MIn with identifiers which indicate that the associated access information ZI1, ZI2, . . . ZIn needs to be transmitted to the means E from the central unit B before payment for and, by way of example, prior to transmission of the relevant charge-incurring data MM1, MM2, . . . MMn. In particular, the central unit B marks that data information MI1, MI2, . . . MIn for which the central unit B expects an overload situation for payment for the charge-incurring data MM1, MM2, . . . MMn. This marking is preferably inaccessible and invisible to the subscriber, that is to say the user of the means E. The prognosis for an overload situation can be ascertained by self-learning knowledge management systems, for example, which evaluate the known and future expected visual and aural behavior of the subscribes at the receiver end. Another option for recognizing overload situations involves using a load distribution analysis system to evaluate the response times of the central unit B, possibly comprising a plurality of servers, or of one of the aforementioned further central units, or a digital rights management allocation system which is separate from the central unit B. The means E is connected to an output unit AE, for example a television receiver, for the purpose of outputting and displaying the data MM1, MM2, . . . MMn and the data information MI1, MI2, . . . MIn.

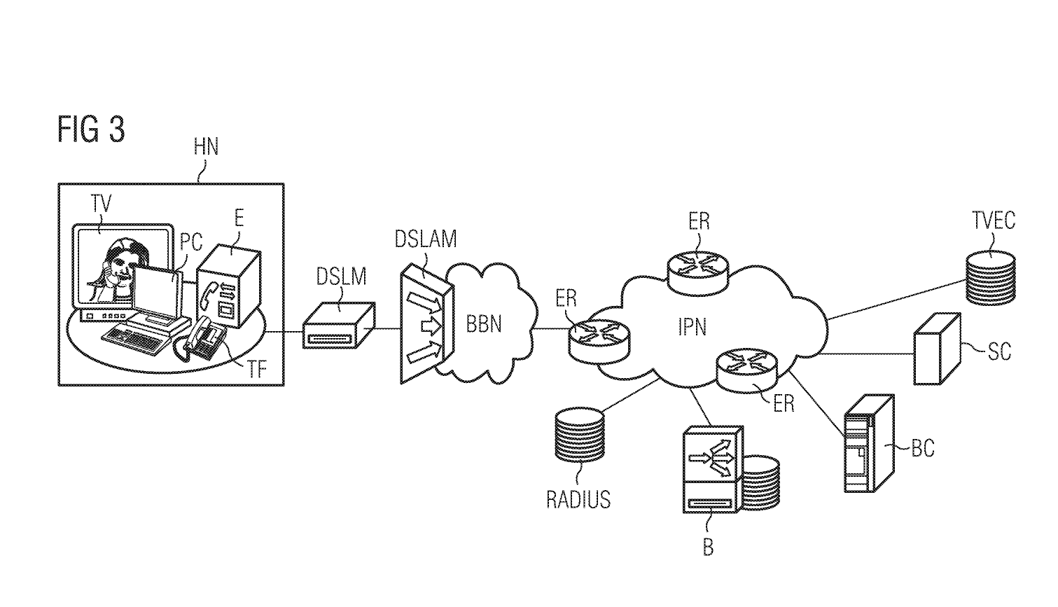

FIG. 3 shows the subject matter of the invention integrated in a multimedia network based on Internet Protocol technology. The means E is part of a home network HN which contains a telephone TF, a personal computer PC, a radio receiver RE and a television receiver TV, for example. A digital subscriber line modem DSLM connects the means E, for example a set-top box, to a digital subscriber line access multiplexer DSLAM on a broadband access network BBN. The broadband access network BBN is in turn connected to the Internet Protocol network IPN via an edge router ER. Further edge routers ER connect a central unit B, a remote authentication dial-in user service server RADIUS, a billing center BC, a security server SC and a television program encoder TVEC to the Internet Protocol network IPN. Alternatively or in addition to the data source TVEC for providing television programs, a video-on-demand server may also be provided as a data source TVEC, this not being shown in FIG. 3.

If no load situation is to be expected for paying for charge-incurring data MM1, MM2, . . . MMn, particularly television programs, in the billing center BC or the central unit B, the request for a charge-incurring television program by a subscriber in the home network HN promotes performance of the payment operation, and the means E receives the access information ZI following successful payment. If it is foreseeable that an overload situation will occur for a charge-incurring television program, said program is marked, as indicated in the description relating to FIG. 2. This marking is available to the means E with the data information MI, also called program data. The program data and the marking are made available to the means E by a download operation. Said operation can be performed by Unicast or Multicast.

The marking is taken as a basis for loading the access information ZI required for the marked television program, such as the channel number, the IP Multicast address of the program and a digital rights management key, into means E likewise as a precaution. This is also done by a download operation in Unicast or Multicast, for example in the same download operation as when the marking and the program data are provided. The download operation is preferably effected in encrypted form. The interface between the central unit B and the security server SC is customized as appropriate for outputting a digital rights management key to the central unit B for the purpose of downloading the key to the means E. Alternatively, the key information can also be obtained directly from the security server SC in a single download operation.

If a subscriber in the home network HN decides, prior to or after the start of a charge-incurring television program, the output and display of said program, the means E attempts to process the payment operation. By way of example, the means E uses the output unit AE to provide the subscriber with an input panel for identifier and password input and, following input by the subscriber, sends these input data to the central unit B. If the central unit B does not respond immediately, for example on account of an overload situation, the means E assumes an overload situation. The means E then immediately accesses the access information ZI, stored in the means E, for the charge-incurring television program, participates in the relevant multicast group and decrypts the television program using the digital rights management key already stored in the means E. That is to say that the subscriber is provided with access to the charge-incurring television program even though he has not yet paid.

During output of the television program, the means E repeatedly turns to the central unit B to initiate the payment operation. Once the central unit B and the billing center BC have come out of the overload state, the payment operation is processed immediately. If the payment operation can be processed with a positive outcome, a positive acknowledgement is sent from the central unit B to the means E, and this concludes the operation.

If the payment operation is not processed with a positive outcome, for example because the subscriber does not have a sufficient balance of payment, a negative acknowledgement is sent to the means E. The means E interrupts output of the charge-incurring television program and displays an appropriate message on the display unit AE, for example.

If the payment operation cannot be performed because the subscriber has made an input error, output is likewise interrupted and a request for fresh input of identifier and password is made. Alternatively, output of the program is not interrupted and the request for input is made while the program is running. If the fresh input also fails to result in a successful payment operation, output of the television program is finally terminated.

It is also possible to mark all multimedia data information MI1, MI2, . . . MIn regardless of an expected overload situation and to supply the means E with all the associated access information ZI1, . . . ZIn as a precaution.

Another use of the exemplary embodiment described in FIG. 3 is the receipt of charge-incurring video data or music data. In this case, there is at least one further server, namely a video-on-demand server or music-on-demand server, for example, which is likewise connected to the Internet Protocol network IPN.

1.-10. (canceled)

11. A method comprising:
via a device of a home network, outputting selectable, charge-incurring data responsive to an evaluation of associated stored access information and a first signaling indicating a current or expected overload situation for a payment operation, said access information stored before said payment operation.

12. The method of claim 11, further comprising:
responsive to a second signaling, terminating said outputting the selectable charge-incurring data, said second signaling indicating said payment operation has not been successfully completed within a stipulated time period.

13. The method of claim 11, further comprising:
responsive to a termination of said outputting the selectable charge-incurring data, outputting a message on a data output device.

14. The method of claim 11, further comprising:
receiving a third signaling during an initialization procedure, said third signaling comprising said access information.

15. The method of claim 11, further comprising:
storing said access information in a first memory device.

16. The method of claim 11, further comprising:
responsive to a positive acknowledgment, said acknowledgement indicating an end of said overload situation, concluding said payment operation.

17. The method of claim 11, wherein:
said first signaling is generated responsive to an absence of an acknowledgement during said payment operation.

18. The method of claim 11, wherein:
said first signaling is generated responsive to a delay in a receipt of a first external message.

19. The method of claim 11, wherein:
said first signaling is generated responsive to a receipt of a second external message.

20. The method of claim 11, further comprising:
receiving a third signaling, said third signaling comprising at least a portion of said access information.

21. The method of claim 11, further comprising:
receiving a third signaling, said third signaling requesting usage of said access information for said outputting the selectable charge-incurring data.

22. A device of a home network comprising:
a first memory unit adapted to store access information associated with selectable charge-incurring data before a payment operation;
a recognition unit adapted to generate a first signaling, said first signaling indicating a current or expected overload situation for said payment operation;
a data interface unit connected to a data transmission network, said data interface unit adapted to receive the access information;
a connection to an output device adapted to output the selectable charge-incurring data; and
said device adapted to output the selectable charge-incurring data responsive to said first signaling and an evaluation of said stored access information.

23. The device of claim 22, further comprising:
a termination unit adapted to output a second signaling indicating said payment operation has not been successfully completed within a stipulated time period, wherein said device is adapted to terminate said outputting the selectable charge-incurring data responsive to the second signaling.

24. The device of claim 22, further comprising:
a data input unit adapted to input the charge-incurring data.

25. The device of claim 22, further comprising:
a second memory unit adapted to store the charge-incurring data in a buffer.

26. The device of claim 22, wherein:
the device is a set-top box.

27. The device of claim 22, wherein:
said data interface unit is adapted to receive the selectable charge-incurring data.

28. A system comprising:
a device of a home network adapted to output selectable, charge-incurring data responsive to an evaluation of associated stored access information and a first signaling indicating a current or expected overload situation for a payment operation, said access information stored before said payment operation.

29. The system of claim 28, further comprising:
a central unit communicatively coupled to said device, the central unit comprising an initializing input unit, wherein during an initialization by the initialization input unit, said access information is stored in said device.
